(19) United States
(12) Patent Application Publication
(10) Pub. No.: US 2006/0066502 A1
(43) Pub. Date: Mar. 30, 2006

(54) Miniature colored digital placard structure

(75) Inventor: Scott Tseng, Taipei Hsien (TW)

Correspondence Address: DENNISON, SCHULTZ & DOUGHERTY, 612 CRYSTAL SQUARE 4, 1745 JEFFERSON DAVIS HIGHWAY, ARLINGTON, VA, 22202, US

(73) Assignee: TAICOM DATA SYSTEMS CO., LTD.

(21) Appl. No.: 10/951,609

(22) Filed: Sep. 29, 2004

(51) Int. Cl. G09G 5/00

(52) U.S. Cl. 345/1.1

(57) ABSTRACT

A miniature colored digital placard structure has on a small wearable housing a colored displaying screen and a communication connecting port for connecting exteriorly for downloading digital image data; the housing has therein a driving control-unit, a memory storing unit, a set of batteries and an automatic playing unit. The driving control-unit is connected on its one end with the communication connecting port, and is connected on its other end with the displaying screen, in order to receive digital image data for converting into images to be presented in the displaying screen. The memory storing unit is connected with the driving control-unit to store the digital image data; the batteries provide electric power required by a circuit; while the automatic playing unit sequentially plays the selected digital image data. The structure can be applied to displaying images on ornaments, various miniature placards or warning marks.

### BACKGROUND OF THE INVENTION

1. Field of the Invention

The present invention is related to a miniature colored digital placard structure, and especially to a miniature colored digital placard structure being allowed of random selecting or changing displaying images and being allowed of downloading and updating displaying images through a network system at any time. The structure is simple and convenient for carrying; it is suitable for applying to displaying images on ornaments, various miniature placards or warning marks.

2. Description of the Prior Art

Ornaments for wearing have the function of setting off brightness and increasing glow of clothes, and more of presenting the self-styles of people; conventional ornaments for wearing of the earlier stage mostly are of the stationary modeling, in the recent years, there have been being light-emitting insignias embedded with LED's together with patterns, so that the insignias can create a vivid flashing decorative and superb attractive effect.

However, the modeling of such insignias is unchanged, and the arrangement of flashing of the LED's is also in a fixed mode, the effect of feeling of dynamic decoration is quite limited and can not be freely developed in pursuance of one's preference; following changing of the times and elevation of the level of consuming, people adore fashion and are fond of making outstanding of their own styles, commodities without changing seem not to satisfy the consumer masses, only those products packed in brilliant and strange modes and miniaturized particularly can be outstanding to attract sights of people.

And more, speaking of the function that patterns and colors can be changed just by randomly inputting signals, a monitor of a computer undoubtedly is the best choice; however, earlier displays are all made from camera tubes, they consume overly large amount of electricity, and are nearly impossible to be made articles able of carrying on ones' persons; nevertheless, following nonstop advancing of science and technology, various techniques for displays are continuously given birth to, and recently liquid crystal displays (LCD) have the superiority of being light, thin and small, as well as low consuming amount of electricity, none danger of irradiation, displaying upright on a flat plane and with stable images without flashing etc.; and colors in liquid crystal displaying monitors are more distinct in layer division, more brilliant and rich, and are larger in contrast; but they are still applied on electronic appliances including personal computers, digital cameras and cameras etc.

In view that displays of various materials have the tendency of being miniaturized and are high quality in color, plus the convenience of Internet nowadays, inspirations are induced to make effective integration of these to popularize the field of application of displays to suit the ambient environment and to provide more usages, and this is the key point of the present invention.

### SUMMARY OF THE INVENTION

The primary object of the present invention is to provide a miniature colored digital placard structure that is simple and convenient for carrying and is allowed of random selecting or changing displaying images and being allowed of downloading and updating displaying images through a network system at any time.

To achieve the above stated object, the miniature colored digital placard structure of the present invention mainly is provided on a small wearable housing with a colored displaying screen and a communication connecting port for connecting exteriorly for downloading digital image data; the housing is provided therein with a driving control-unit, a memory storing unit, a set of batteries and an automatic playing unit. The driving control-unit is connected on its one end with the communication connecting port, and is connected on its other end with the colored displaying screen, in order to receive digital image data for converting into images to be presented in the colored displaying screen. The memory storing unit is connected with the driving control-unit to store the digital image data; the batteries provide electric power required by a circuit; while the automatic playing unit can sequentially play the selected digital image data.

The present invention will be apparent after reading the detailed description of the preferred embodiment thereof in reference to the accompanying drawings.

### BRIEF DESCRIPTION OF THE DRAWINGS

FIG. 1 is a schematic block view showing connecting of the elements of an embodiment of the present invention;

FIG. 2 is a perspective view showing the appearance of the embodiment of the present invention;

FIG. 3 is a perspective schematic view showing a plurality of the embodiments of the present invention mutually connected in series to form an ornament;

FIG. 4 is a perspective schematic view showing the embodiment of the present invention is displaying time;

FIG. 5 is a schematic view showing the embodiment of the present invention is used as a placard;

FIG. 6 is a schematic view showing the embodiment of the present invention is provided with a hanging hook.

### DETAILED DESCRIPTION OF THE PREFERRED EMBODIMENT

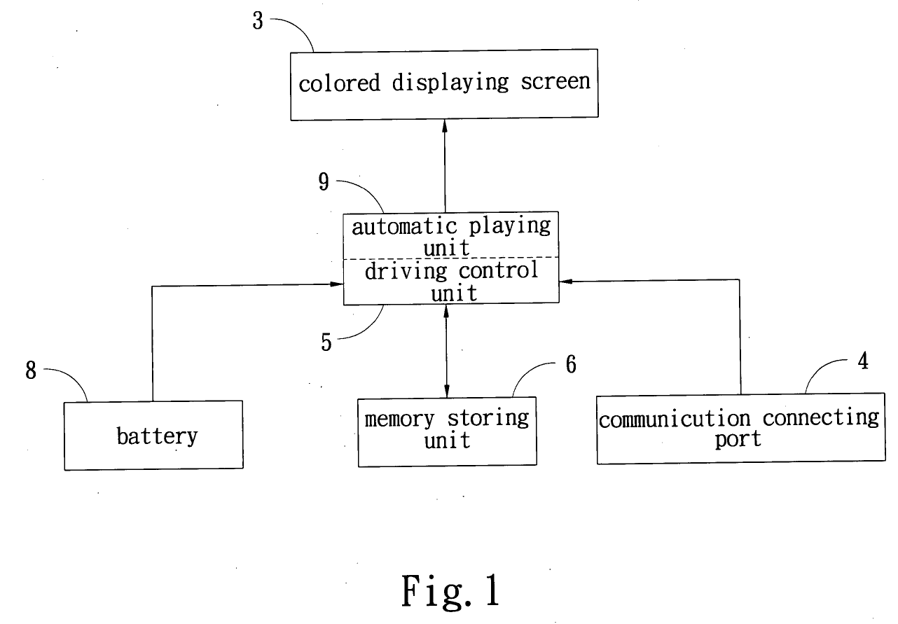

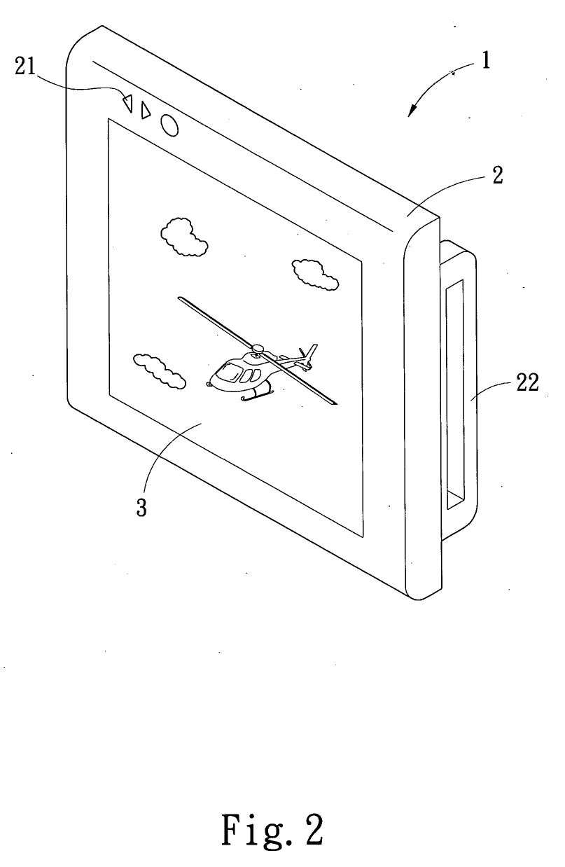

Referring firstly to FIGS. 1, 2 showing an embodiment of the miniature colored digital placard structure 1 of the present invention, the embodiment mainly is provided on a small wearable housing 2 with a colored displaying screen 3, and a communication connecting port 4 for connecting exteriorly for downloading digital image data; the housing is provided therein with a driving control-unit 5, a memory storing unit 6, a set of batteries 8 and an automatic playing unit 9.

Wherein the housing 2 is provided on its surface with a push key 21 for adjusting and controlling. The driving control-unit 5 is connected on its one end with the communication connecting port 4, and is connected on its other end with the colored displaying screen 3; the communication connecting port 4 is a universal serial bus (USB), when it is connected with an electronic equipment, it can download and receive digital image data by the mode of network transmitting, the digital image data received are converted into images through the driving control-unit 5 to be presented in the colored displaying screen 3. The memory storing unit 6 is connected with the driving control-unit 5 to store the digital image data; the batteries 8 provides electric power required by a circuit; while the automatic playing unit 9 can sequentially play the selected digital image data.

Therefore, when in use, the driving control-unit 5 can be connected in the first place via the communication connecting port 4 with an electronic equipment such as a mobile phone, a card reader or a computer to download and receive digital image data required by a user by the mode of network transmitting, the digital image data received can be stored in the memory storing unit 6 for reading of the driving control-unit 5, the digital image data read by the driving control-unit 5 is then converted into images to be presented in the colored displaying screen 3. The user only needs to set by means of the push key 21 on the surface of the housing 2; he can immediately switch and adjust the way and sequence of displaying the patterns.

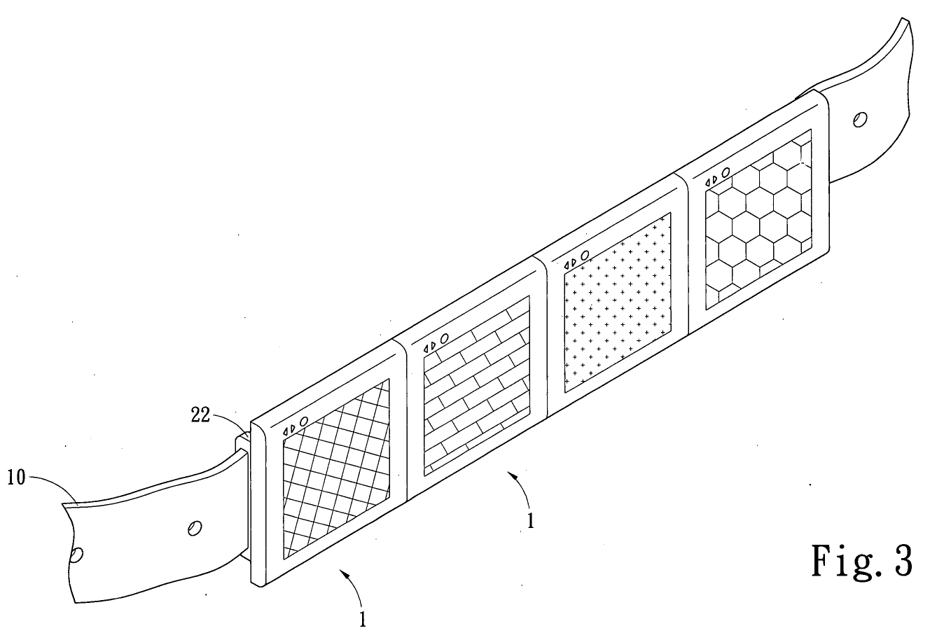

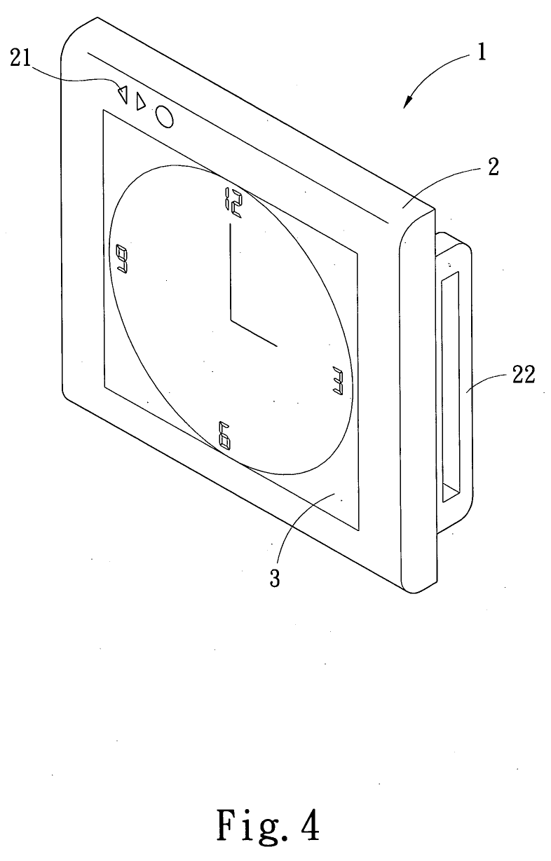

As shown in FIG. 3, a consumer can wear a single or a plurality of (in series) the embodiments in application. Each of the housings 2 is provided thereon with a connecting area 22, so that the plural miniature colored digital placard structures 1 can be worn on the user for decoration by means of a belt 10 or a wristlet and by connecting in series to form a light emitting ornament. The user can download a brand new fashion of pattern from the network through the communication connecting port 4 in pursuance of his fondness or tendency of fashion; moreover, in order to make a product more practicable, the miniature colored digital placard structure 1 can be built therein with a clock (as shown in FIG. 4); the clock can be connected with the automatic playing unit 9, so that it can be used as an alarm clock that can change its flashing patterns at will in addition to that it is used to show time in a normal simple way.

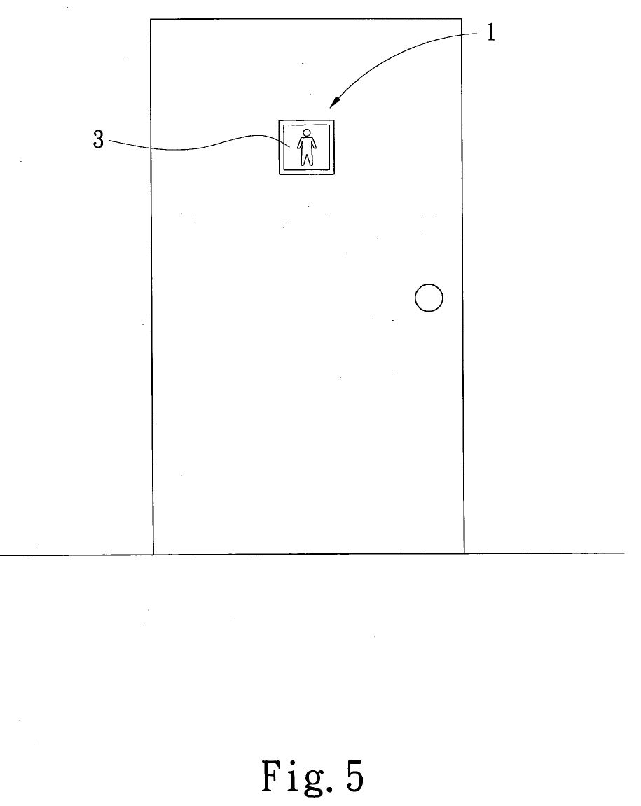

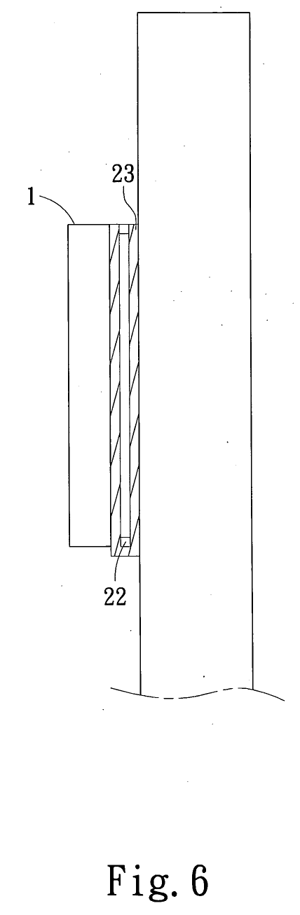

Referring further to FIGS. 5 and 6, by virtue that the present invention has the function of downloading a pattern at will for displaying, the present invention can be augmented and used as a placard for indicating changeable contents, and can be fixed on a door or a wall by means of a hanging hook 23 (or by applying glue on its back), and the selected patterns or slogans downloaded can be shown thereon, thus the object of indicating can be achieved. By the fact that the patterns can be further loaded to be variant, thereby, a single structure can completely take the place of most conventional indicating placards with fixed patterns. The present invention not only is practicable, but also can increase the beautiful appearance by using colors.

The present invention thereby has the following advantages:
1. The miniature colored digital placard structure of the present invention is structurally simple and convenient for use, a user can random select or change displaying images and can download a brand new fashion of pattern through a network system at any time.
2. The miniature colored digital placard structure of the present invention has small and exquisite modeling, it is very convenient for carrying, and can be used as an ornament in mating with the modeling of a dress; besides, it can be used as an indicating placard, patterns shown therein can have more variations in pursuance of the requirements of people, fields and articles, thus the value of its product can be increased.

In conclusion, according to the description disclosed above, the present invention surely can get the expected object thereof to provide a miniature colored digital placard structure. Having thus described the invention being extremely valuable in having practicability,

What I claim as new and desire to be secured by Letters Patent of the United States are:

1. A miniature colored digital placard structure, said structure is provided on a small wearable housing with a colored displaying screen and a communication connecting port for connecting exteriorly for downloading digital image data; said housing is provided therein with a driving control-unit, a memory storing unit, a set of batteries and an automatic playing unit, wherein:
said communication connecting port downloads and receives digital image data from an electronic equipment;
said driving control-unit is connected on its one end with said communication connecting port, and is connected on its other end with said colored displaying screen, in order to receive said digital image data for converting into images to be presented in said colored displaying screen;
said memory storing unit is connected with said driving control-unit to store said digital image data;
said batteries provide electric power required by a circuit; and
said automatic playing unit sequentially plays said digital image data selected;
thereby, said digital image data is adapted for downloading to said miniature colored digital placard structure for presenting.

2. The miniature colored digital placard structure as in claim 1, wherein said communication connecting port is a universal serial bus (USB), when it is connected with said electronic equipment, it downloads and receives digital image data.

3. The miniature colored digital placard structure as in claim 1, wherein said communication connecting port downloads and receives digital image data from said electronic equipment by the mode of network transmitting.

4. The miniature colored digital placard structure as in claim 1, wherein said electronic equipment is one of a mobile phone, a card reader and a computer.

5. The miniature colored digital placard structure as in claim 1, wherein said housing is provided thereon with a connecting area, so that plural ones of said miniature colored digital placard structure are connected in series.

6. The miniature colored digital placard structure as in claim 1, wherein said housing is provided thereon with a push key for adjusting and controlling.

7. The miniature colored digital placard structure as in claim 1, wherein said housing is applied with glue on its back.

8. The miniature colored digital placard structure as in claim 1, wherein said housing is provided on its back with a hanging hook.

9. The miniature colored digital placard structure as in claim 1, wherein said structure is built therein with a clock.

10. The miniature colored digital placard structure as in claim 1, wherein said structure is used as an indicating placard by the mode of displaying.
